(19) United States
(12) Patent Application Publication
(10) Pub. No.: US 2014/0193144 A1
(43) Pub. Date: Jul. 10, 2014

(54) METHOD AND APPARATUS FOR MULTIPLE CAMERA ALIGNMENT AND USE

(71) Applicant: Leonard Coster, Sun Valley, CA (US)

(72) Inventor: Leonard Coster, Sun Valley, CA (US)

(21) Appl. No.: 14/110,405

(22) PCT Filed: Apr. 9, 2012
(86) PCT No.: PCT/US2012/032798

§ 371 Date: Mar. 19, 2014

Related U.S. Application Data
(60) Provisional application No. 61/472,830, filed on Apr. 7, 2011.

(51) Int. Cl. G03B 35/08

(52) U.S. Cl. CPC G03B 35/08
USPC 396/325

(57) ABSTRACT

A camera rig system is provided for 3D stereo photography. The system includes a first camera mount configured to removably hold a first camera module having a first optical axis being oriented horizontally. The system also includes a second camera mount configured to removably hold a second camera module having a second optical axis being oriented vertically and orthogonal to the first optical axis. The system further includes a mirror assembly configured to receive an incoming light and transmit a first portion of the incoming light to the first camera module and reflect a second portion of the incoming light to the second camera module. The mirror assembly has a first rotational axis, and the mirror assembly independently controls a rotational movement around the rotating axis and a linear movement along at least one of the first optical axis and the second optical axis.

### CROSS REFERENCE TO RELATED APPLICATIONS

This application claims benefit under 35 U.S.C. §119(e) of U.S. Provisional Application No. 61/472,830, filed Apr. 7, 2011, entitled “A Method and Apparatus For Multiple Camera Alignment and Use,”, which is hereby incorporated by reference in its entirety.

### FIELD OF THE INVENTION

The present invention generally relates to a camera mounting apparatus and corresponding method of use, and particularly relates to a multi-camera mounting apparatus and method of use offering fast and highly accurate alignment of multiple cameras for stereoscopic and high dynamic range photography and filming.

### BACKGROUND

Anyone with two eyes normally experiences stereo vision. To convey stereo vision photographically it is necessary to obtain two images from different positions and then deliver these, one each, to each of the viewers eyes.

For stereo photography, typically two cameras are used, offset from each other horizontally by a distance called the Inter-axial distance or Inter-ocular distance (“IOD”). These two cameras can be aimed at the subject and the two photographs taken.

When images are delivered correctly to the viewers' eyes, the appearance of stereo vision from the position of the cameras is observed. A suitable “3D rig” is therefore an arrangement of cameras that allows such stereo photographs to be taken. Fundamentally, if the images are not correctly aligned when exhibited it may cause degradation in the clarity of the image, progressing to increasing levels of eyestrain and fatigue for the viewer of such footage, and finally leading to images so misaligned that the viewer is not able to “fuse” the images into a stereogram.

It is therefore desirable to align the cameras as accurately as possible when acquiring the images. Even so there may be undesirable distortions between the left and right eye images, which maybe corrected before the images can be exhibited. Such post photographic correctional process is time consuming and technically challenging in its own ways and is therefore expensive. Additionally, post-production processing practically cannot fully repair all forms of distortion so therefore the less post correction needed, the better both in terms of quality and expediency.

There are many methods for delivering stereoscopic images to the viewer but the common requirement is that the image from the left camera go to the viewer's left eye only and similarly, the image from the right camera to the viewer's right eye only.

One possible method as commonly used in 3D cinemas today is to use two projectors and polarizing filters. One projector projects the image for the left eye via say a left circular polarizing filter and the other the image for the right eye using a right circular polarizing filter. This system utilizes a so called “silver screen” by which is meant a screen with a specular surface, or one that preserves polarization on reflection. Standard white cinema screens do not do this.

Each viewer is equipped with polarized eyewear. That is, each viewer is equipped with eyewear that delivers the left-circular polarized image to the wearer's left eye, while blocking the right-eye image. Correspondingly, the eyewear delivers the right-circular polarized image to the wearer's right eye, while blocking the left-eye image. Without the glasses, a viewer would see both images superimposed on top of each other and the three-dimensional effect would be destroyed. But with the glasses on, each eye sees only the image intended for it. The effect is depicted in the below diagram, where “L” denotes the left image intended for the viewer's left eye and “R” denotes the right image intended for the viewer's right eye.

In a known type of “side-by-side” camera rig, two cameras are placed side-by-side and aimed in the direction of the subject. Each camera represents the perspective view from the left or right eye. While this is probably the simplest arrangement to implement and understand, it does have certain limitations in applicability.

An effective 3D rig may allow a variable IOD to be set between the cameras. There is a point in every lens called the nodal point. It is found along the axis of the lens, often but not necessarily near the iris. The IOD between the two cameras is measured as the horizontal distance between the two nodal points of the two lenses. There is no vertical distance between the cameras or their associated nodal points. Greater IOD results in greater perception of depth in the scene. If the IOD is set to zero—i.e., both cameras pointing down the same axis—then the images obtained from the two cameras, all other things being equal, would be the same and effectively it is just a 2D image.

There are limits to IOD in so-called side-by-side rigs, where two cameras are placed next to each other in the horizontal plane. Indeed, a major limitation of side-by-side rigs is that the minimum IOD that can be set on such a rig is determined by the physical size of the cameras and lenses. Once these components are touching it is not possible to reduce the IOD further. In many circumstances, it is necessary or desirable to use an IOD smaller than the physical size of the cameras used and hence the development of the beam splitter 3D rig.

In “beam splitter rigs” a mirror that divides the light is used to effectively split the incoming light into two separate paths that can be photographed by two cameras whose physical mounting and positioning will no longer obstruct each other as they would when mounted side by side.

This means that such cameras can be configured with an IOD less than the physical size of said cameras without physically obstructing each other. Beam splitter rigs are in common usage in stereo photographic environments. But whatever mechanical arrangement is used for stereo photography, one may align the dual cameras accurately to produce a clear image for the viewer.

A first alignment parameter is referred to as “horizontal displacement,” which is the horizontal distance between the camera axes—i.e., the IOD and may be set exactly as calculated to achieve the desired degree of parallax difference between the images captured by the first camera and the corresponding images captured by the second camera.

A second alignment parameter is referred to as “horizontal angular displacement,” which is the horizontal angle between the camera axes and will be understood as being the convergence angle between the two cameras. This parameter is the degree of “toe in” between the axes of the cameras as measured from parallel.

A third alignment parameter is referred to as “vertical displacement.” In a correctly aligned rig there will be no vertical displacement between the camera axes as any offset in this direction is equivalent to the viewer's eyes being at different heights in his or her head.

A fourth alignment parameter is referred to as “vertical angular displacement.” In a correctly aligned rig there will be no vertical angular displacement between the camera axes as this would be equivalent to one eye of the viewer aiming up or down relative to the other and such displacements therefore badly degrade the image quality of the final stereogram. These alignments take very long time and are not cost effective.

Further, as discussed above under IOD and convergence—the cameras are usually some distance apart horizontally (the IOD) and at some angle “toe in” towards each other (convergence angle) but they do not, in a correctly aligned camera rig, introduce vertical displacement or angular offset.

It is desirable to align the cameras such that they are: (1) at the same height; and (2) parallel in the vertical plane. Here, “at the same height” will be understood to mean that optical axes of the two stereo cameras are at the same height—in beam splitting rigs, one camera generally is physically lower than the other camera.

### SUMMARY

In one aspect, this disclosure provides a system for fast and accurate alignment of multiple cameras for the capture of stereo and high dynamic range images, and other parallax data.

In an embodiment, a camera rig system is provided for 3D stereo photography. The system includes a first camera mount configured to removably hold a first camera module having a first optical axis being oriented horizontally. The system also includes a second camera mount configured to removably hold a second camera module having a second optical axis being oriented vertically and orthogonal to the first optical axis. The system further includes a mirror assembly configured to receive an incoming light and transmit a first portion of the incoming light to the first camera module and reflect a second portion of the incoming light to the second camera module. The mirror assembly has a first rotational axis, and the mirror assembly independently controls a rotational movement around the rotating axis and a linear movement along at least one of the first optical axis and the second optical axis, the first rotating axis being orthogonal to the first optical axis and the second optical axis.

In an embodiment, a method is provided for aligning camera modules in a camera rig system for 3D stereo photography. The system includes at least two fixed camera modules and a movable mirror assembly. The method includes mounting a first camera module in a horizontal orientation and a second camera module in a vertical orientation onto respective camera mounts. The method also includes rotating the mirror assembly around a first rotational axis. The method further includes moving the mirror assembly along at least one of a first optical axis of the first camera module and a second optical axis of the second camera module, such that the incoming light transmitting through the mirror assembly toward the first camera module and the incoming light reflecting from the mirror assembly toward the second camera module are coincident at a reflective surface of the mirror assembly. The first optical axis, the second optical axis, and the first rotational axis are perpendicular to each other, the mirror assembly is angled at roughly 45 degrees from the first optical axis or the second optical axis.

In an embodiment, a method is provided for aligning camera modules in a camera rig system for 3D stereo photography. The system includes at least two fixed camera modules and a movable mirror assembly. The method includes mounting a first camera module in a horizontal orientation and a second camera module in a vertical orientation onto respective camera mounts. The method also includes moving the mirror assembly along a first optical axis of the first camera module and a second optical axis of the second camera module. The method further includes rotating the mirror assembly around a first rotational axis such that the incoming light transmitting through the mirror assembly toward the first camera module and the incoming light reflecting from the mirror assembly toward the second camera module are coincident with an intersection point of the first rotational axis and a second rotational axis being perpendicular to the first rotational axis. The first optical axis, the second optical axis, and the first rotational axis are perpendicular to each other, the mirror assembly is angled at roughly 45 degrees from the first optical axis or the second optical axis.

The teachings disclosed herein apply to various applications, including but not limited to motion picture and still photography, stereo imaging, high dynamic range imaging, mixed spectrum imaging (e.g., visible and infrared), and parallax depth data collection with two or more cameras.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 illustrates a camera rig including a mirror box in an embodiment.

FIG. 2 illustrates a simplified camera rig without the rig frame and camera mounts of FIG. 1.

FIG. 3 illustrates the mirror box of FIG. 1.

FIG. 4A is a simplified diagram illustrating rotational movement of a mirror assembly around a tilt axis in the mirror box of FIG. 3 with respect to two fixed camera modules in an embodiment.

FIG. 4B is a simplified diagram illustrating horizontal movement of a mirror in the mirror box of FIG. 3 with respect to two fixed camera modules in an embodiment.

FIG. 4C is a simplified diagram illustrating vertical movement of a mirror in the mirror box of FIG. 3 with respect to two fixed camera modules in an embodiment.

FIG. 4D is a simplified diagram illustrating both horizontal and vertical movements of a mirror in the mirror box of FIG. 3 with respect to two fixed camera modules in an embodiment.

FIG. 5 illustrates two-axis linear movement of the mirror assembly in an embodiment.

FIG. 6 is a side view of two cameras illustrating IOD in an embodiment.

FIG. 7 is a perspective view of the mirror assembly without mirror in an embodiment.

FIG. 8 is a perspective view of the mirror assembly from the top in an embodiment.

FIG. 9 is a perspective view of the mirror assembly with drive details in an embodiment.

FIG. 10 is another perspective view of the camera rig with belt system in an embodiment.

FIG. 11 is another perspective view of the camera rig from a backside of the camera rig in an embodiment.

FIG. 12 is a simplified diagram of an electronic adjustment system in an embodiment.

FIG. 13 is a perspective view of the camera rig with lift bearings in an embodiment.

FIG. 14 is a perspective view of the camera rig with lift cage for lift bearing in an embodiment.

FIG. 15 is a perspective view of the camera rig a rotation cage assembly in an embodiment.

FIG. 16 is a perspective view of the camera rig with push bearings in an embodiment.

FIG. 17 is a perspective view of the camera rig with push cage in an embodiment.

FIG. 18 is a perspective view of the camera rig with tilt bearing supports in an embodiment.

FIG. 19 is a perspective view of the camera rig with a tilt cage assembly in an embodiment.

### DETAILED DESCRIPTION

The present disclosure provides a system for fast and accurate alignment of multiple cameras for the capture of stereo and high dynamic range images, and other parallax data. In an embodiment the system is realized in an apparatus referred to as a multi-camera rig for fast, accurate, and robust alignment of the multiple cameras. In a particular embodiment, the multi-camera rig is adapted to hold two cameras in a desired alignment for stereoscopic (3D) photography.

In one embodiment, the multi-camera rig includes a mirror assembly that provides a reflected view of a scene being imaged into a first camera that is removably carried in a first camera mount of the multi-camera rig and provides a transmitted view of the scene into a second camera removably carried in a second camera mount of the multi-camera rig. The mirror assembly includes a beam splitter element, e.g., a planar mirror configured to have coequal or non-coequal reflectance and transmittance values. For ease of discussion and by way of non-limiting example, the beam splitter element is referred to simply as a “mirror” within the mirror assembly. At minimum, the mirror assembly is a mirror.

The mirror assembly abstracts the lens axes. in one embodiment, the mirror assembly includes an adjustable carriage. The carriage includes a mount in which the mirror is fixed and provides a rotation of the mirror about a first axis of the mirror. The carriage also provides tilting rotation of the mirror about a second axis of the mirror.

To provide for the alignment of the axes of the two cameras mounted in the multi-camera rig, the carriage provides for two degrees of linear movement of the mirror, in addition to the two degrees of rotational movement. More particularly, in an example frame of reference, a first camera or camera module including a camera lens mounts under the mirror assembly and is pointed upward towards the downward tilting face of the mirror within the mirror assembly. This camera is referred to as the “vertical” or the “reflected-view camera” because it looks upward towards the mirror and receives a reflected scene from the downward tilting, planar face of the mirror. Correspondingly, the second camera or camera module including a camera lens mounts horizontally and looks “through” the mirror. As such, the second camera is referred to as the “horizontal” or “transmitted-view” camera.

It will be understood that each camera has an optical axis that extends outward along an optical centerline or axis of the camera lens, and that the lens nodal point falls somewhere along that line, at a position that depends on camera focal length and other constructional characteristics of the particular lens. The two degrees of linear motion provided by the carriage within the mirror assembly allow the mirror to be moved up or down relative to the vertical camera mounted below the mirror assembly and to be moved forward and backward relative to the horizontal camera mounted behind the mirror assembly. This up/down and forward/backward adjustability allows the reflected and transmitted axes of the cameras to be aligned relative to one another.

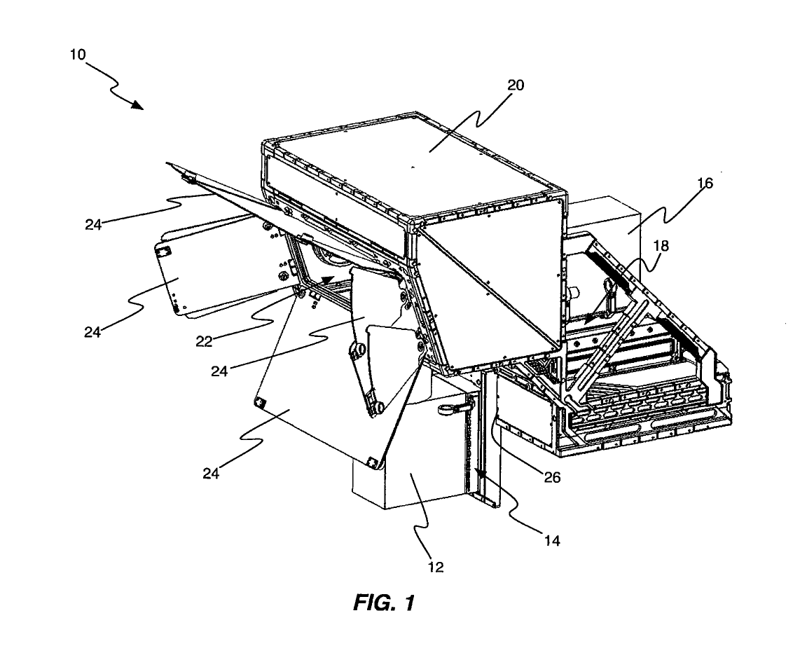

FIG. 1 illustrates a camera rig 10 according to one embodiment. Advantageous aspects of the camera rig's construction and operation enable fast, accurate, and robust alignment of multiple cameras for multi-view photography or filming—generically referred to as “photography.” In the illustrated example, the camera rig 10 is configured to removably carry a first camera 12 in a first camera mount 14 and a second camera 16 in a second camera mount 18.

Within the depicted frame of reference, the first camera 12 mounts in a vertical orientation “looking up” into a mirror box 20 and it receives a reflected view of a scene visible through an opening 22 in the front of the mirror box 20. (Note that the opening 20 may be closable, via one or more folding covers or doors 24.) Again, within the context of the depicted frame of reference, the second camera 16 mounts in a horizontal orientation “looking through” the mirror box 20 and it receives a transmitted view of the scene. The mirror box 20 includes a mirror or other suitable beam splitter element that reflects a portion of incident light into the first camera 12, while passing a portion of light—transmitted light—through to the second camera 16.

A rig frame 26 carries or otherwise integrates the camera mounts 14 and 18 and mirror box 20 into a rigid support structure. Complementing this frame rigidity, the camera mounts 14 and 18 are also configured for robust retention of the cameras 12 and 16, respectively, to maintain their alignment. Here, it may be noted that one or more of the camera mounts 14 and 18 provide some degree of adjustability, such as side-to-side positioning, but they are designed to robustly hold their respective cameras 12 and 16 in a desired position during use. It will appreciated by those in the art that more than two camera modules may be mounted.

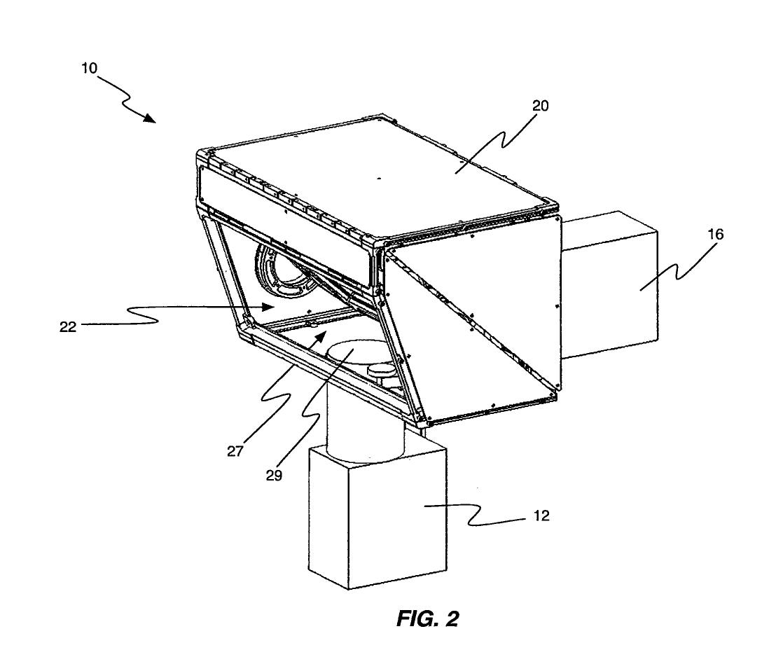

FIG. 2 depicts the camera rig 10 from the same perspective as shown in FIG. 1, but it omits the rig frame 26, the camera mounts 14 and 18, and other details, simplifying discussion of mirror box 20. For example, one sees an opening 27 in the mirror box 20, which permits reflected light from the mirror box to enter the lens assembly 29 of the first camera 12. It will be appreciated that a backside of the mirror box 20 includes a similar opening for the lens assembly of the second camera 16 (not shown in this view).

The camera rig 10 provides fast and accurate alignment of multiple cameras for the capture of stereo and high dynamic range images, and other parallax data. In particular, unlike known camera rigs for 3D or other multi-camera photography, the camera rig 10 contemplated herein provides significant advantages in convenience, performance, and efficiency of use. In one particular aspect, a number of advantages are gained by abstracting the lens axes of the two cameras 12 and 16 through use of the beam lifting mirror within the mirror box 20.

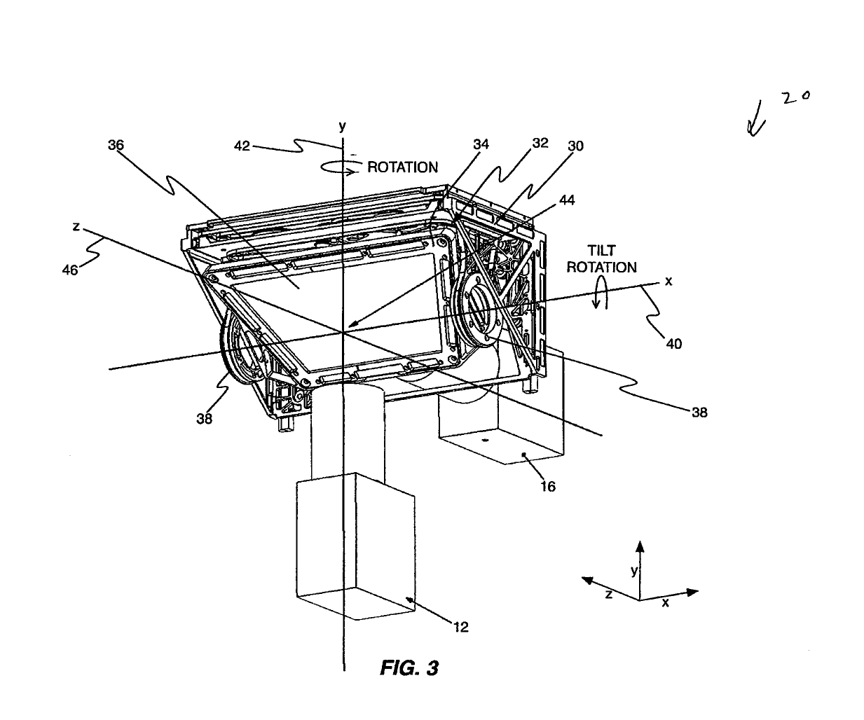

FIG. 3 reveals interior components for an embodiment of the mirror box 20. One sees a carriage 30 holding a mirror assembly 32 that includes a rigid frame 34 holding a mirror 36. The mirror 36 functions as a beam splitter that reflects a portion of incoming light into the first camera 12 held in the first camera mount 14 and passes a portion of incoming light to the second camera 16 held in the second camera mount 18.

Rotational mounts 38 carry the mirror assembly 32 within the carriage 30. The rotational mounts 38 rotate the mirror assembly 32 around a tilt axis 40, which is denoted as the “x” axis in FIG. 3. While not shown in FIG. 3, the carriage 30 further includes a rotational mechanism that rotates the mirror assembly 32 around an axis 42, which is denoted as the “y” axis in FIG. 3. The axis 42 runs orthogonal to the tilt axis 40 and they intersect at a point 44 on the reflective face of the mirror 36.

The carriage 30 provides two degrees of linear movement for the mirror assembly 32. Within the depicted frame of reference, a first linear drive mechanism (not explicitly detailed in FIG. 3) moves the mirror assembly 32 up and down along the axis 42. A second linear drive mechanism (not explicitly detailed in FIG. 3) moves the mirror assembly back and forth along depth axis 46, which is labeled as the “z” axis. Further, in at least one embodiment, the mirror 36 is configured to be moved, e.g., by manual and/or motorized adjustment, along the x axis.

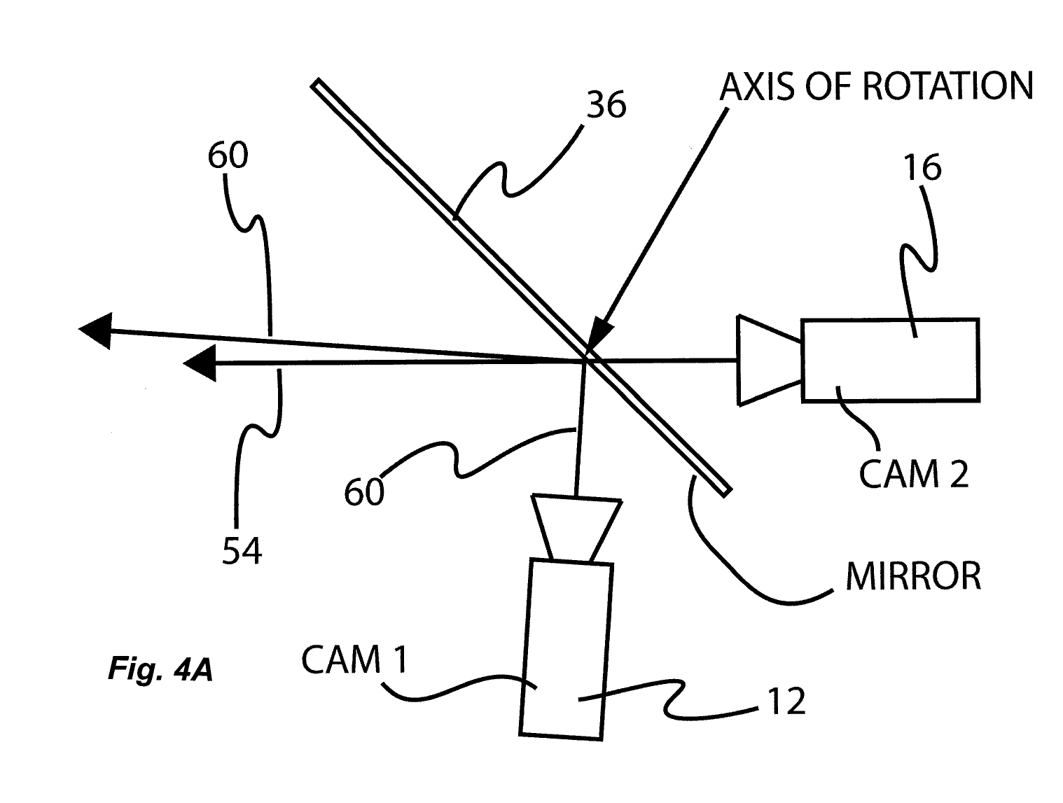

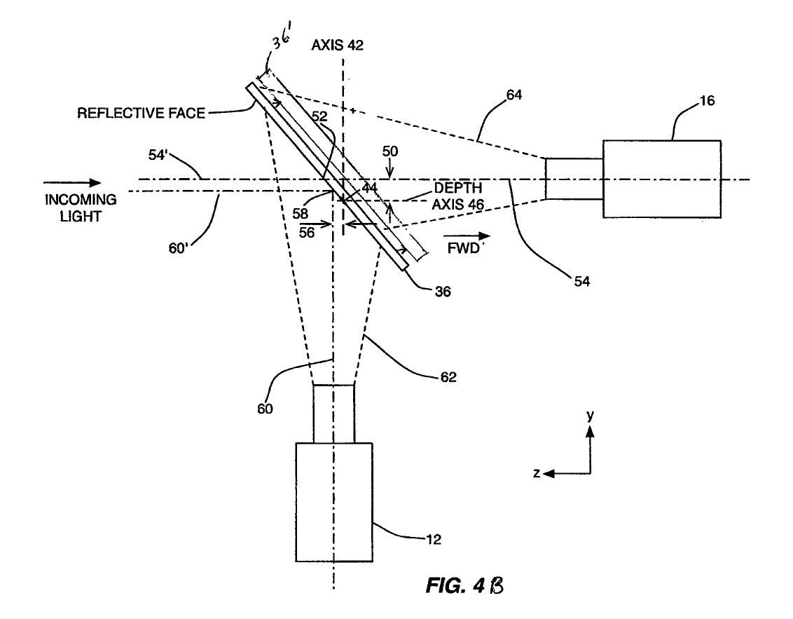

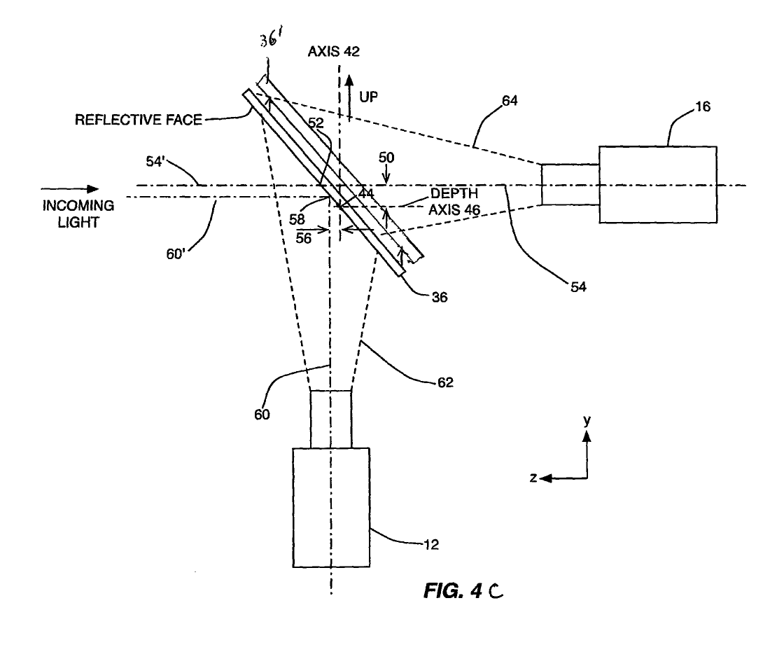

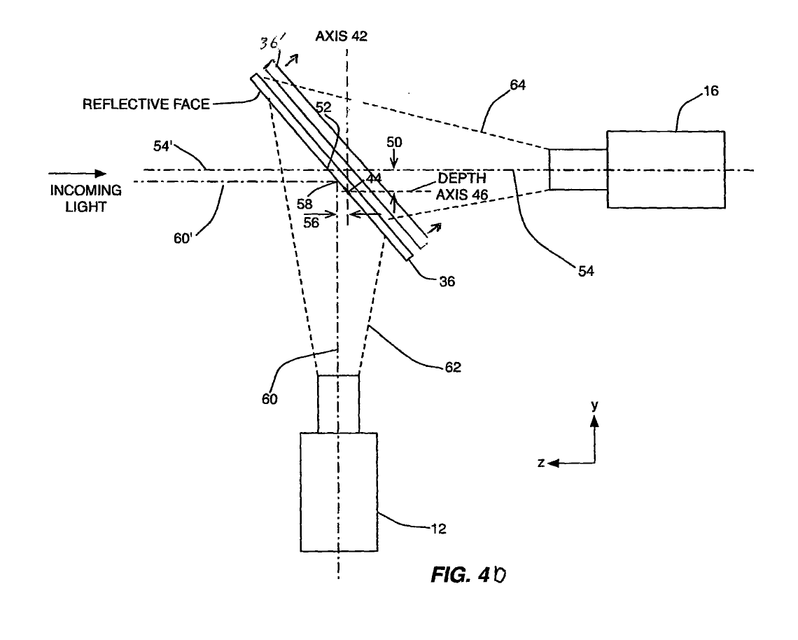

FIG. 4A is a simplified diagram illustrating rotational movement of a mirror assembly around a tilt axis in the mirror box of FIG. 3 with respect to two fixed camera modules in an embodiment. As shown in FIG. 4A the mirror box 20 provides for correction of any vertical angle errors, for example, where correction of any vertical angular displacements between the reflected optical axis 60′ of the first camera 12 and the transmitted optical axis 54′ of the second camera 16. The mirror box 20 achieves this by tilting the mirror 36 about the tilt axis 40. It will be appreciated that the inadvertently tilted position of the first camera 12 is exaggerated for purposes of illustration—such tilting may be a defect in the camera body, etc.

Adjusting the mirror tilt angle allows the reflected optical axis of the first camera 12 to be made parallel with the transmitted optical axis of the second camera 16. Here, it will be understood that the transmitted optical axis—i.e., the “through-the-mirror” optical axis of the camera 16 nominally does not change as the tilt angle of the mirror 36 changes. (Of course, any practical, non-zero-thickness mirror will displace the transmitted optical axis by a small amount (see Snell's Law) and this displacement can be taken into account.

In a particular embodiment, the rotational movement of the mirror assembly is within approximately 2 degrees. Followed by a rotation movement of the mirror 36 around the tilt axis, the mirror 36 may have a linear movement.

FIG. 4B is a simplified diagram illustrating horizontal movement of a mirror in the mirror box of FIG. 3 with respect to two fixed camera modules in an embodiment. The mirror 36 is moved horizontally to a new position as mirror 36′. In a particular embodiment, the linear movement of the mirror assembly is along a horizontal axis within 1.5 inches. In this embodiment, there is no force due to gravity other than frictional forces to overcome in horizontal movement.

In an alternative embodiment, the linear movement may be in a vertical orientation. FIG. 4C is a simplified diagram illustrating vertical movement of a mirror in the mirror box of FIG. 3 with respect to two fixed camera modules in an embodiment. The mirror 36 is moved vertically to a new position as mirror 36′.

In a further embodiment, the linear movement may be in both horizontal and vertical orientations. FIG. 4D is a simplified diagram illustrating both horizontal and vertical movements of a mirror in the mirror box of FIG. 3 with respect to two fixed camera modules in an embodiment. The mirror 36 is moved as the arrow points to a new position as mirror 36′.

FIG. 4D further illustrates linear movement of the mirror 36 up and down along the axis 42 and forward and backward along the depth axis 46. It will be understood that FIG. 4D presents a side view, with the tilt axis 40 into the paper and the axis 42 (the y axis) being a vertical axis. Further from the diagram one sees that sliding the mirror 36 up and down along the axis 42 can be used to correct misalignment between the reflected and transmitted axes of the cameras. In the illustrated example, moving the mirror 36 upwards by the amount of misalignment 50 will place the reflected axis 60′ in alignment with the optical axis 54 of the second camera 16.

However, moving the mirror 36 up and down along the axis 42 does not correct a misalignment 56 between a mirror intersection point 58 of the optical axis 60 of the first camera 12. Instead, movement forwards and backwards along the depth axis 46 is used to correct the misalignment 56.

It will be understood from the above explanation that a combination of linear movement along the z axis and the y axis, as provided by the mirror box 20 for the mirror 36 is used to eliminate any vertical displacement between the transmitted optical axis 54′ of the second camera 16 and the reflected optical axis 60′ of the first camera 12. (The transmitted optical axis 54′ simply refers to the optical axis 54 of the first camera 16 on the other side of the mirror 36. Likewise, the reflected optical axis 60′ refers to the optical axis 60 of the first camera 12, as reflected from the vertical to the horizontal by the tilted mirror 36.)

It will be further understood that the above linear adjustments—i.e., movement of the mirror 36 up and down along the y axis and forward and back along the z axis—can be performed to position the reflected optical axis 54′ coincident on the mirror surface. The transmitted optical axis 60′ will be level (in terms of y axis elevation) with the reflected optical axis 54′, but may be offset relative to each other (along the x axis) as the IOD and convergence are adjusted. However, the transmitted optical axis 60′ is unaffected by tilting and rotation of the mirror 36, while the reflected optical axis 54′ is affected by tilting and rotation of the mirror 36.

Linear movement of the mirror 36 along the axis 42 and along the depth axis 46 also can be used to adjust where the fields of view (FOVs) 62 and 64 of the first and second cameras 12 and 16 fall onto the mirror's surfaces, and to control how much of the field of view is captured. It is desirable that the full FOV 62 of the first camera 12 and the full FOV of the second camera 16 fit within the usable surface areas of the mirror 36. In this respect, one sees the divergent nature of the FOVs 62 and 64. Thus, moving downward, closer to the first camera 12 reduces mirror surface area needed to capture the full FOV 62, while moving backward, closer to the second camera 16 reduces the mirror surface area needed to capture the full FOV 64.

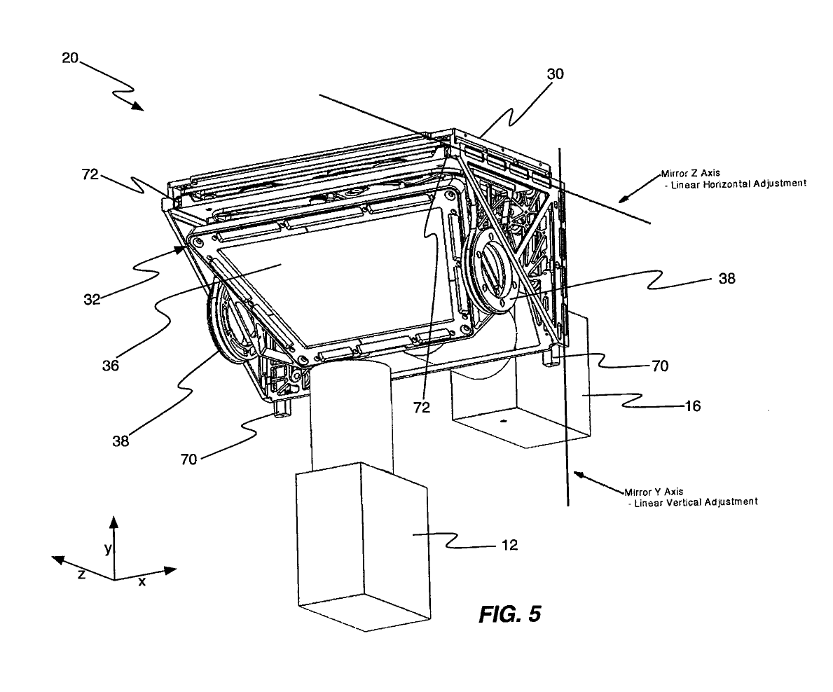

The overall effect of two-axis linear movement, as described above, is further illustrated in FIG. 5, wherein the carriage 30 or a subassembly thereof slides up and down along a pair of vertical rails 70 for linear adjustment along the y axis. The carriage 30 or a subassembly therefore slides back and forth along a pair of horizontal rails 72 for linear adjustment along the z axis.

Note that while the carriage 30 provides for linear travel of the mirror assembly 32 up and down along the axis 40 (y axis) and forward and back along the depth axis 46 (z axis), it is generally fixed to prevent side-to-side linear travel along the tilt axis 40 (x axis). In this regard, assuming the nominal frame of reference in FIG. 3, it will be appreciated that movement back and forth along the tilt axis 40 represents left/right or lateral movement horizontally within the FOVs 62 and 64 of the first and second cameras 12 and 16. Thus, the lateral offset along the x axis between the optical centerlines of the first and second cameras 12 and 16 represents the parallax between the two cameras, referred to as the inter-ocular distance (IOD).

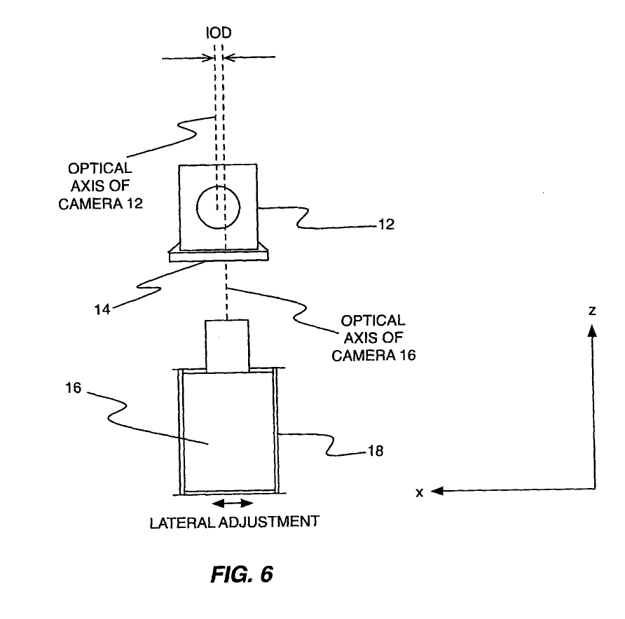

In one embodiment, the mirror box 20 fixed in terms of its relative x-axis positioning and the mirror nodal point 44 establishes the x-axis origin. Correspondingly, the first camera mount 14 is configured to mount the first camera 12 in general alignment with the x-axis origin of the mirror 36, and the second camera mount 18 for the second camera 16 is adjustable along the x-axis, to set the desired IOD. This arrangement is illustrated in simplified fashion in the plan view of FIG. 6, which can be understood as looking down the y axis.

From the above, it will be understood that changing the tilt of the mirror 36, which is nominally at 45 degrees, changes the vertical angular displacement between the transmitted optical axis 54′ of the second camera 16 and the reflected optical axis 60′ of the first camera 12. Thus, tilt adjustment of the mirror 36 can be used to zero out any such vertical angular displacement. Moreover, it will be recognized that combinations of linear movement along the y and z axes can be used to zero out any vertical displacement between the reflected optical axis 54′ and the transmitted optical axis 60′, while simultaneously controlling where the FOVs of the two cameras 12 and 16 fall on the mirror's front and back surfaces, respectively.

As such, the mirror box 20 provides for quick and accurate adjustment of the vertical displacement between the two cameras 12 and 16 via its linear drive mechanisms that provide linear movement along the z and y axes, and provides for quick and accurate adjustment of the vertical angular displacement of the two cameras 12 and 16 via its tilt rotation, respectively.

As for the remaining stereoscopic alignment parameter, the horizontal displacement between the two cameras 12 and 16 generally is provided for in one or both of the camera mounts 14 and 18. For example, in one embodiment the cameras are removably mounted and fixed into place with a specified horizontal displacement for the desired IOD. However, in one or more other embodiments, the camera rig 10 allows IOD to be changed between or during a shot. Such an adjustment is independent, and thus will not affect the other alignment parameters.

In one implementation of this embodiment, the camera mount 18 for the second camera 16 includes a sliding mechanism that allows the camera 16 to move back and forth along the x axis. The sliding mechanism provide for manual adjustment via a knob or screw. Additionally, or alternatively, a motorized linear drive mechanism is incorporated into the camera mount 18—such as a linear screw drive. This motorized drive mechanism may be manually controlled, e.g., via operator input, or may be “intelligent” and responsive to IOD control commands that specify a desired IOD setting. Further, in at least one embodiment, it contemplated to have position sensing and feedback, allowing a camera operator to see the IOD as it is being adjusted.

Position sensing is implemented, for example, using a rotary encoder on a screw drive mechanism—with a zero or reference IOD position indicated. As another example, the IOD adjustment mechanism may be driven with a stepper motor drive, so that positional changes can be tracked in terms of drive steps, which can be mapped to inches or some other unit of measure for lateral movement.

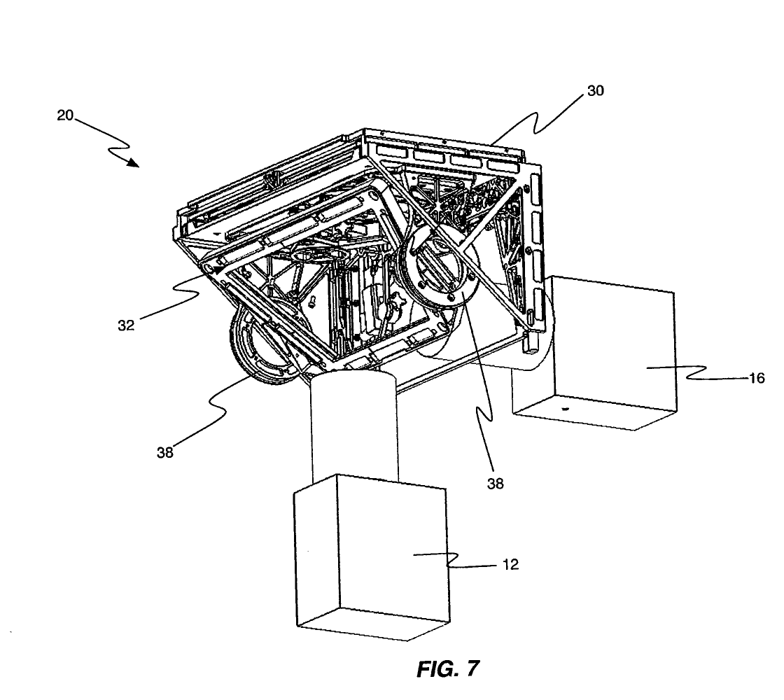

FIG. 7 returns to the perspective view and reveals additional example details of the carriage 30 and mirror assembly 32. Here, the mirror 36 is removed for a better view of the rotational mounts 38.

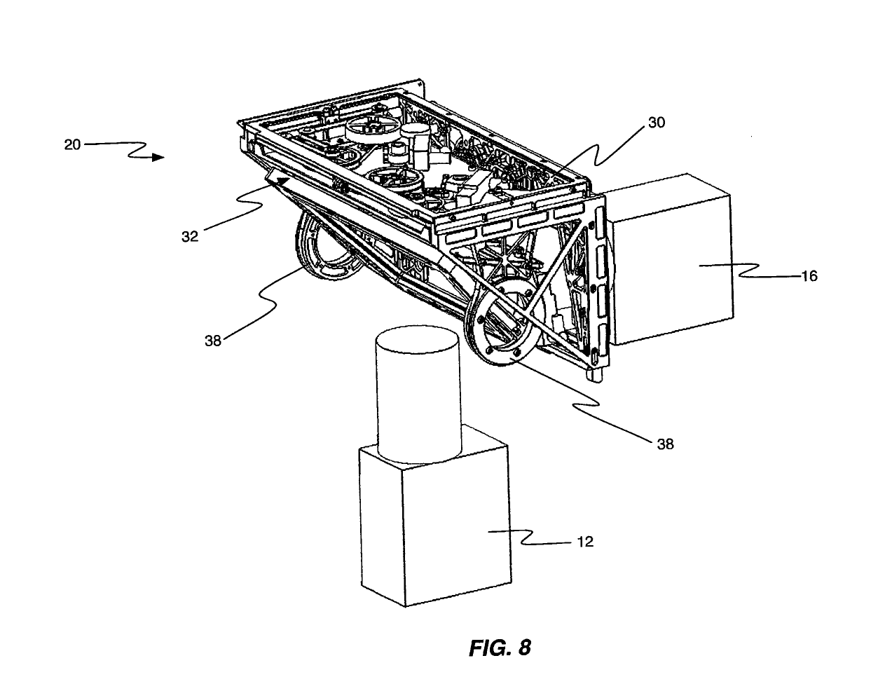

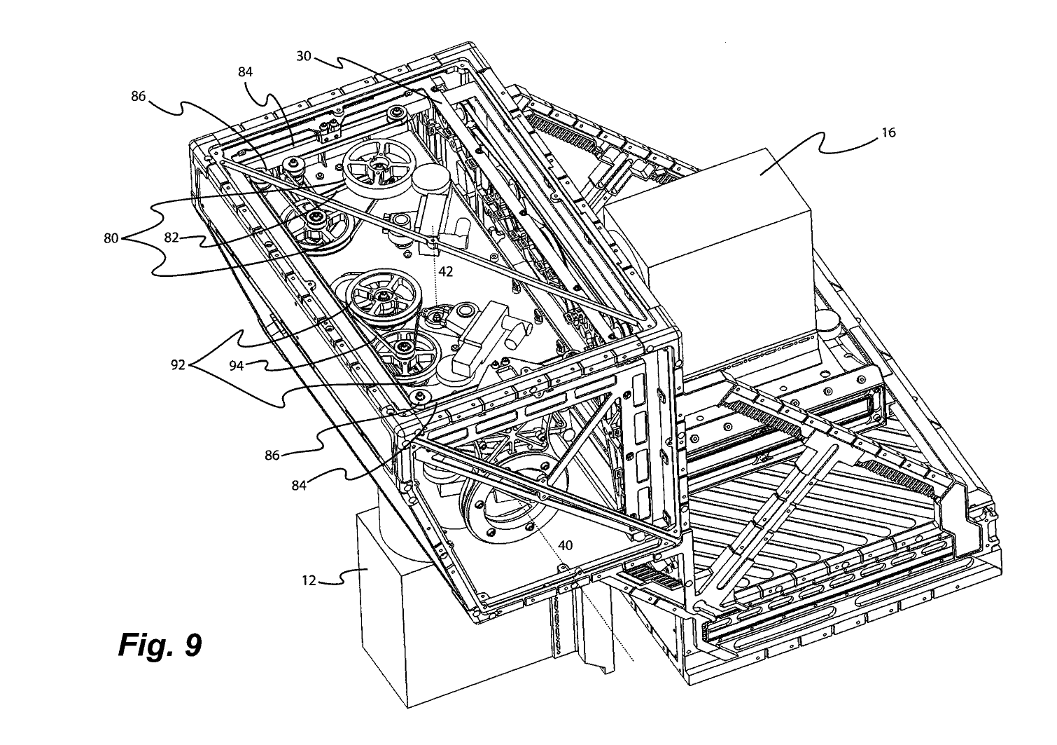

FIG. 8 is similar to FIG. 7, but the view represents a higher elevation along the y axis. As such, a top-side of the carriage 30 is revealed, showing example details for linearly moving the mirror assembly 32. FIG. 9 moves the perspective to an even higher illustration and provides further drive details.

In particular, one sees a belt and pulley drive assembly representing the second linear drive mechanism discussed earlier. Here, the drive assembly includes first and second drive pulleys 80, coupled by a drive belt 82. Rotation of the pulleys 80 imparts motion to a driven belt 84, which is threaded around a series of spindles 86. Movement of the driven belt 84 in one direction moves the mirror assembly 32 linearly forward along the z axis, while movement in the opposite direction moves the mirror assembly linearly backward along the z axis. Notably, the arrangement of spindles 86 at opposing corners offsets drive forces and prevents torquing of the carriage 30 and thereby avoids binding.

FIG. 9 also discloses a second belt and pulley drive assembly that is configured as a first rotating mechanism for the mirror 36. In particular, the second belt and pulley drive assembly provides for tilting rotation of the mirror assembly 32 about the tilt axis 40. The second belt and pulley drive assembly a pair of pulleys 92, and a drive belt 94 interconnecting the two pulleys 92. Rotation of the drive belt 94 in one direction tilts the mirror 36 upwards, while rotation in the other direction tilts the mirror 36 downwards.

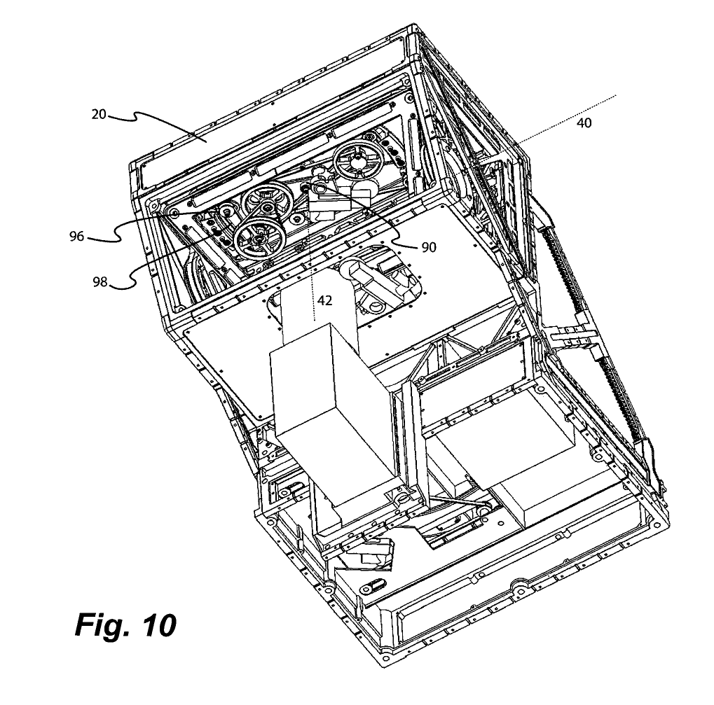

FIG. 10 provides another perspective view with the tilt and pan axes 40 and 42 highlighted. FIG. 10 also shows a roller wheel or other bearing 96 riding in an arcuate slot 98 allows the mirror assembly 32 to pivot about the axis 42 within the carriage 30. More particularly, FIG. 10 provides example details for a belt system serving as the rotational mechanism for rotation of the mirror 36. Here, belt 98 engages the bearing 96 such that when the gears are turned and the belt actuated it will rotate the mirror assembly 32 about the axis 42. The similar principal of applying force on both sides of the actuated part to avoid binding in operation is also applied here.

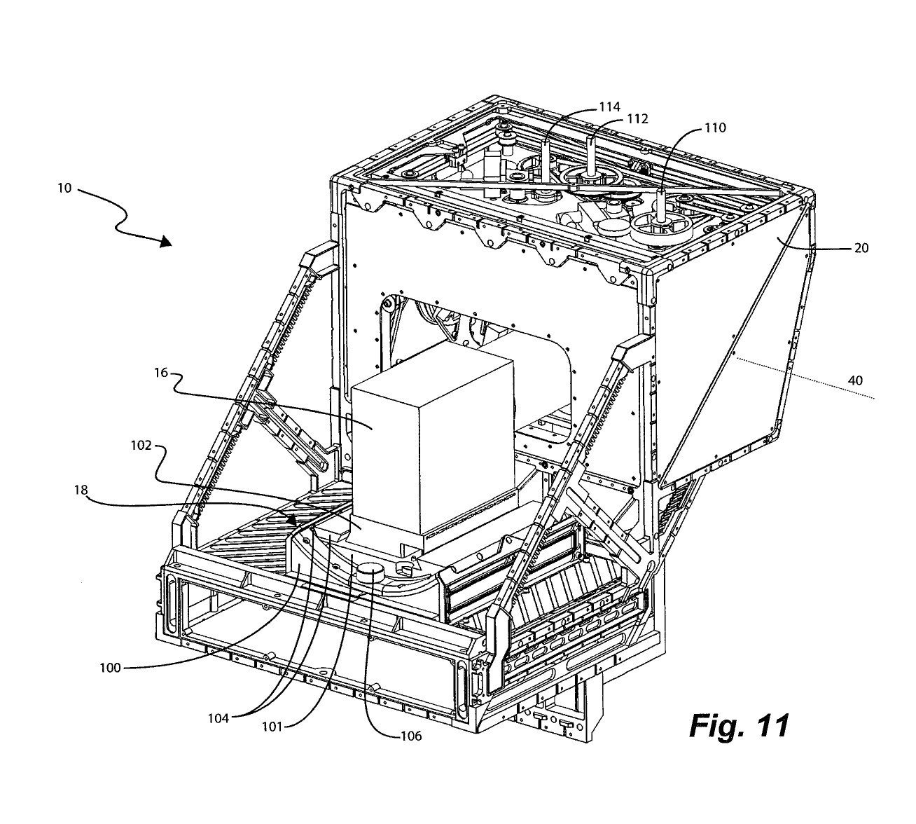

FIG. 11 illustrates yet another perspective view of the camera rig 10, which shows the backside of the camera rig 10 and reveals additional example details for the second camera mount 18. The discussion of FIG. 6 described a lateral adjustment feature of the second camera mount 18, which allowed the second camera 14 to be positioned at a desired lateral offset along the x axis from the first camera 12. The adjustable lateral offset established the IOD or parallax setting between the two cameras 12 and 16.

The illustrated embodiment of the second camera mount 18 includes a first base portion 100 having a cylindrical or otherwise arcuate section or channel that carries a second based portion 101, and an adaptor plate 102 that bolts or otherwise fastens to the camera 18. A dovetail clamping mechanism 104 and associated thumbscrews may be used to secure the adaptor plate 102/camera 16 to the base portion 101. Different adaptor plates 102 may be used to accommodate different types of camera body bolt patterns and/or shapes, and to accommodate off-center camera bodies. All such adaptor plates 102 would have common mating dimensions for seating into the base portion 101.

The curved channel in the base portion 100, and the complementary curvature of the base portion 101, allows the camera 16 to be rotated approximately about its optical axis to the extent that the thickness of the base portion 101 is correct for the characteristics of the camera 16. As such, different base portions 101 will have differing thicknesses for different camera models. Note that the mirror's ability to move linearly along the y and z axes accommodates height offsets in this regard.

As noted, the dovetail clamping mechanism 104 and thumbscrews allow an operator to lock the camera 16 down in a desired position in the camera mount 18. A similar base/adaptor plate and dovetail locking mechanism may be used for the first camera mount 14, although the first camera mount 14 may or may not incorporate the curved base 100 for rotational adjustment of the first camera 12.

In any case, it will be appreciated that the first and second camera mounts 14 and 18 allow an operator to securely mount the first and second cameras 12 and 16 to the camera rig 10, and then adjust the mirror box 20, as needed, to achieve the desired optical alignment of the two cameras—i.e., to make tilt rotational adjustments and to make y and/or z axis adjustments.

In at least one embodiment, one or more of these adjustments are made using manual adjustment knobs or dials—e.g., a tilting knob, and knobs for linearly sliding the mirror box 20 up and down along the y axis or forward and back along the z axis. For example, FIG. 11 shows spindles 110, 112, and 114 extending upward. These spindles may pass through the enclosure of the mirror box 20 and carry manual adjustment knobs.

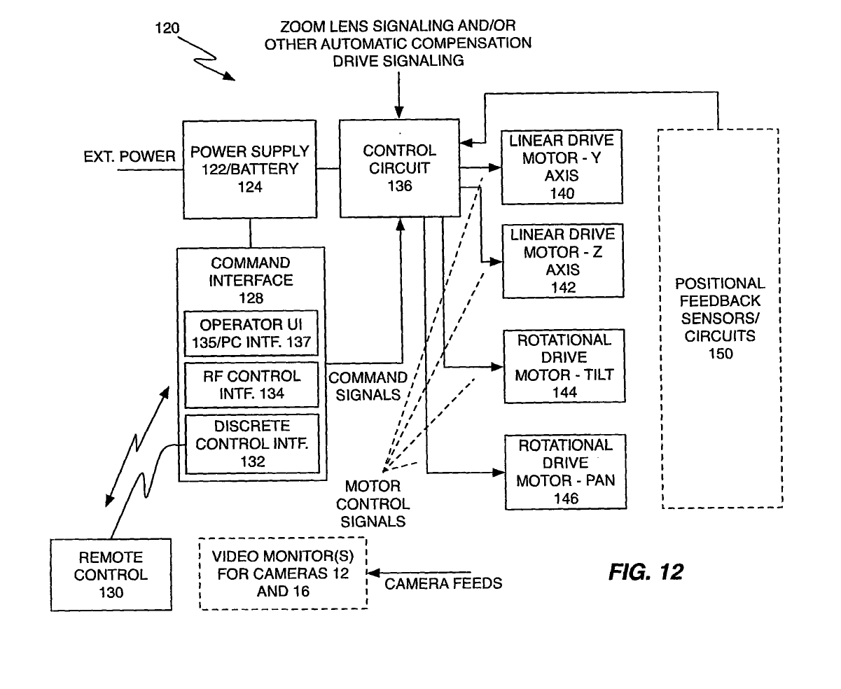

However, as FIG. 12 shows, in at least one embodiment, the mirror box 20 is motorized and includes an electronic adjustment system 120, which is integrated into the camera rig 10. In the illustrated example embodiment, the system 120 includes a power supply 122 and optional battery 124. The power supply comprises, for example, an AC/DC converter configured to operate from an external power supply, e.g., a 120-240 VAC supply, and to provide power at one or more regulated DC levels. In another embodiment, the system 120 is configured to directly receive the DC power and the power supply 122 is omitted or at least simplified—e.g., it may comprise surge protection/reverse polarity protection, fusing, etc.

The system 120 further includes a command interface 128, for receiving adjustment commands, e.g., from a remote control box 130 controlled by a camera rig operator. The command interface 128 receives commands from the remote control 130, for example. In one embodiment, the remote control 130 has a wired interface—e.g., a detachable cable—that interconnects it to the command interface 128. In such embodiments, the command interface 128 may have a discrete control interface 132. In one example embodiment, the discrete control interface 132 includes a number of voltage-mode inputs that represent linear and rotational commands for the mirror box drive motors.

In another embodiment, the command interface alternatively or additionally includes a radio frequency (RF) control interface 134, for receiving radio commands from an RF-equipped version of the remote control 130. In at least one such embodiment Note that such communications may be two-way—e.g., the command interface 128 may transmit status or positioning signaling back to the remote control 130.

Indeed, in one embodiment, the command interface 128 provides feedback indicating the current positional settings of the mirror 36, for example, in terms of y and z axes positions. (Position along the x axis also may be indicated, in cases where the camera rig 10 includes x axis position adjustment of the mirror 36, or provides for electronic sensing of the x axis displacement of the camera 16 for desired IOD positioning.) Further, in one or more contemplated embodiments, the system 120 includes an operator interface 135, such as a display screen and keypad, that allows an operator to input desired positioning for the mirror 36, or to otherwise control motorized adjustment of the mirror position. It is also contemplated that the system 120 can save configured settings, such as in named files that can be recalled and automatically implemented by the system 120. The system 120 also may execute power-on zeroing of the mirror position.

Still further, the system 120 in one or more embodiments further includes a PC interface 137, which provides for interconnectivity with a laptop or other computing device and allows mirror adjustments to be controlled using the user interface of the connected computer. The PC interface 137 comprises, for example, a USB interface.

In any case, the command interface 128 provides a control circuit 136 with command signals, which may be discrete high/low signals representing motor on/off and direction commands. The control circuit 136 generates motor control signals responsive to the command signals, and these motor control signals drive the various motors associated with articulating the mirror assembly 132 as described earlier herein. In one example implementation, a first drive motor 140 provides linear up/down movement for the mirror assembly 132 along the y axis; a second drive motor 142 provides linear forward/backward movement for the mirror assembly 132 along the z axis; and third drive motor 144 provides rotational movement for the mirror assembly 132 about the tilt axis 40; and a fourth drive motor 146 provides rotational movement for the mirror assembly 132 about the axis 42.

In one embodiment, the control circuit 136 additionally or alternatively responds to zoom lens signaling and or other automatic compensation drive signaling. For example, cameras with motorized zoom lenses can provide a zoom control signal to the control circuit 136. The signal may be analog or digital. For example, if a zoom lens uses a constant-speed motorized zoom, then the zoom lens signaling may comprise a logic level signal that is asserted for a duration of time corresponding to active zoom adjustment of the lens—different polarities or different zoom signals may be used to indicate whether the lenses are zooming in or out. In any case, the control circuit 136 may control, e.g., the adjustment of the mirror 36 by driving the motor 146 for a duration of time or for a number of degrees needed to adjust mirror alignment, as needed to accommodate the changed zoom setting.

The mapping may be a one-to-one mapping, where the rate of change of angle matches the rate of change in lens zooming, so mirror adjustment runs for the duration of zoom adjustment. Alternatively, the amount of zoom change (and the direction in or out) is provided to the mirror box and the control circuit 136 computes the corresponding change in angle and drives the motor 146 accordingly. In at least one embodiment, the control circuit 136 comprises a microprocessor-based circuit, including data and program memory, or comprises some other digital processing logic, e.g., a complex programmable logic device or FPGA. As an example, the control circuit 136 may include a microcontroller that has onboard timers and/or PWM circuitry for implementing motor control signaling. The microcontroller also may include or have associated with it one or more analog-to-digital converters for monitoring proportional positioning signals, etc.

Thus, in at least one embodiment, all or part of the mirror adjustment is driven by a microprocessor or other digital processing circuit, based on the execution of computer program instructions stored in a memory (e.g., non-volatile memory or other non-transient computer readable medium). In at least one such embodiment, the system 120 is configured to read stored data representing a desired mirror position (in terms of linear and rotational positioning). Such data can be in external memory, such as a USB or Flash drive connected to the PC interface 137. In at least one such embodiment, multiple configuration files can be detected by the system 120, with a corresponding listing displayed to an operator for selection of the desired configuration file.

Of course, the system 120 also can be implemented in one or more embodiments using discrete circuits, such as discrete transistor and relays, to control the motors responsive to the command signals. In one or more other embodiments, the system 120 comprises a mix of discrete circuits and programmed digital processing circuitry.

With electronic controls especially, the system 120 may include positional feedback circuits/sensors 150, for one or more of the linear and/or rotational adjustments of the mirror 36. For example, the control circuit 136 may receive “zero” position feedback for the mirror 36 with respect to its y and/or z axis movement. Likewise, the control circuit 136 may receive “zero” angle feedback for the mirror 36 with respect to its nominal tilt and/or rotation angles.

The nature of the positional feedback circuits/sensors 150 generally will depend upon the type of motors and drive mechanisms used. For example, with linear, screw-type drives, hall-effect sensors and/or photo-interrupter circuits can be used to sense when the mirror assembly 32 occupies its “nominal” linear and/or angular position(s) and motor encoder wheels can be used to detect linear and/or rotational movement away from those nominal position(s). Further, to the extent that stepper motors are used, the control circuit 136 can be provided with nominal or zero position feedback signals indicating the nominal or zeroed position of the mirror assembly 32 and then use motor step count tracking (with a known relationship between linear movement and/or angular change and each motor step) to track its controlled changes in the mirror's linear and/or rotational movements.

In one or more embodiments, the camera rig 10 (e.g., via the system 120) allows the operator to “slave” any desired parameters to one or more other inputs. For example, the convergence angle (pan) and IOD values may be mapped to certain focus values such that as the focus is changed, the system 120 synchronously and proportionately changes the convergence and IOD. It will be understood that the control circuit 136 receives signaling—whether analog or digital—associated with changes in focus, etc., so that it can automatically respond to such changes by activating the motorized controls that are slaved to such changes.

Of course, one or more embodiments additionally or alternatively provide manual angle adjustments, allowing an operator to manually adjust the angle and/or other ones of the alignment parameters.

Whether motorized, or configured for manual adjustment, or configured to permit both motorized and manual adjustment, the camera rig taught herein provides rapid and accurate alignment of the cameras 12 and 16. In particular, the camera rig 10 and its articulation of the mirror 36 within the mirror box 20 provide completely “nodal” adjustment of the stereo parameters (IOD and convergence) of the first and second cameras 12 and 16, even when used with zoom lenses. These advantages can be quickly achieved for many different camera and lens combinations, including zoom lenses.

Achieving nodal alignment involves a number of steps, including a first step involving adjustment of the camera heights so that the optical axes of camera 12 and camera 16 both strike the mirror 36 at the same elevation.

The mirror box 20 provides for this adjustment by providing for movement of the mirror 36 perpendicular to its surface, either diagonally down or diagonally upward. Such diagonal movement is achieved by a combination of linear movement along the z axis and along the y axis, which can be seen in the below diagram:

This above-described articulation of the mirror 36 provides the unique advantage that the cameras 12 and 16 can be solidly mounted without the need for further articulation and the adjustment made independently of them. This point is significant because of the variety of mounts, shapes and sizes of cameras; it is convenient to be able to mount the heavy and delicate camera-and-lens assembly solidly and then adjust the alignment without risk to the camera or awkward articulations. According to the teachings herein, the mirror box 20 is controlled so that the mirror 36 is moved into a position where, with respect to the cameras 12 and 16 mounted in fixed positions in their respective camera mounts 14 and 18, the optical axes of both cameras intersect the mirror 36 at the mirror nodal point 44.

One important point to note here is that adjustment of the mirror 36 has achieved accurate alignment of the transmitted optical axis 54′ without reference to the nodal point of the camera lens other than that the axis of that lens still goes through its nodal point. It does not matter how close to the mirror 36 the camera 16 is mounted or if the lens nodal point of camera 16 moves, as it will do in zoom lenses, along the axis of the lens.

The adjustment made at the nodal point 44 of the mirror 36 is still valid and correct and is not affected by a change in the lens nodal point. Nor does aligning the vertical angle using this method affect any other alignment axis—they are all completely independent. This independence greatly simplifies initial set-up and alignment of cameras and/or realignment if changes are made—e.g., if the lenses or the cameras are swapped out for different ones.

Once the cameras' vertical displacements are zeroed out using the y and z axis linear adjustments provided by the mirror box 20, and the vertical angle is adjusted to parallel using the mirror's tilt adjustment, the camera rig 10 has achieved, very quickly and simply, accurate alignment.

These features, including the ability to preserve alignment with varying focal Length—focal length tracking—are part of the key advantages offered by the contemplated camera rig 10, in terms of the accuracy and speed of alignment, and provides a significant advantage over competing systems.

Further, by articulating the mirror 36, the camera rig 10 can compensate for non-nodal alignment errors in 3rd party equipment. An example might be a zoom lens where, as the focal length is changed, the elements of that lens do not track exactly along the axis of the lens and the image consequently appears to pan or tilt away from center.

In a normal 2D photograph this effect is not an issue as the camera can be tilted or panned to re-frame as desired. However, in a 3D rig, unless the two lenses of the first and second cameras 12 and 16 miss-track identically, they will change relative framing—as if the viewer's eyes moved independently of each other to look at different objects in the frame. Such an effect is very disturbing and significantly degrades or even destroys the integrity of the stereogram.

However, with the mirror box 20 presented herein, as the stereo images mis-track due to the described lens distortion, the mirror 36 can be quickly moved to maintain accurate alignment of the images from the first and second cameras 12 and 16.

In a further embodiment of this design said movement of the mirror will be motorized and automatic versus the position of the zoom lens. This feature was shown in FIG. 12, for example, where the control circuit 136 generated motor drive signals for moving the mirror 36 in response to zoom lens signaling and/or other automatic compensation signal.

Regardless of such optional features and details, it will be appreciated that the camera rig 10 broadly provides independent adjustment of: (1) the vertical linear position of the mirror 36—i.e., linear travel along the y axis; (2) the horizontal linear position of the mirror 36—i.e., linear travel along the z axis; (3) the vertical angular adjustment of the mirror 36—i.e., tilt rotation of the mirror 36 about tilt axis 40.

Keeping these degrees of freedom completely independent from each other provides for rapid and accurate adjustment of alignment of the camera rig 10, as correction of one parameter does not misalign another in the adjustment process. In particular, referring back to FIGS. 3-5, linear adjustment of the mirror position in the YZ plane, as defined by the figures, relative to the camera axes makes it possible to adjust the intersection point of the axes of the two cameras 12 and 16 to be coincident on the mirror surface with each other and the tilt axis 40 of the mirror 36.

By linear adjustment of the camera 12 and/or 16 along the X axis (IOD adjustment for the second camera 16 in the horizontal position) it is possible to arrange the camera axes to be coincident on the mirror surface with each other.

In one or more embodiments, the first camera 12 (the vertical camera) is adjusted along the X axis by fitting of the correct adaptor plate—e.g., a version of the adaptor plate 102 shown in FIG. 11, but one intended for the first camera mount 14. In most cases the mounting points provided by the camera manufacturers are in a line parallel with the axis of the camera. Where this is not the case a camera adaptor plate with slotted mounting points can be used to allow the necessary degree of freedom for lateral adjustment of the camera within its rig mount.

The second camera 16 (the horizontal camera) is adjusted along the X axis by use of the IOD mechanism in the camera rig 10—refer again to FIG. 11 where the camera mount 18 provides for side-to-side adjustment of the adaptor plate 102, which serves as the mounting plate for the second camera 16. Alignment in this sense can be considered as a simple zero offset of this control in the camera rig 10.

As noted, vertical angular adjustments are made via the mirror tilt axis 40. These adjustments pivot about the mirror nodal point 44. Further, the linear y-z movement of the mirror 36 permits the mirror 36 to be moved to make the optical axes 60 and 54 of the first and second cameras 12 and 16, respectively, intersect the mirror 36 at the mirror nodal point 44. Therefore, there is no linear displacement of the camera axes due to tilt/pan angular adjustment of the mirror 36 and the degrees of freedom thus remain independent. Of course, this assumes a mirror of zero thickness and is only strictly valid along the axes of the camera lenses. At any other point on the mirror 36 within the FOV of the camera lens, such adjustments will be distorted by a real physical mirror of non-zero thickness. However, the mirror 36 even with its real-world imperfections will nevertheless be optimally configured.

With the above in mind, in one embodiment herein, a camera rig 10 is configured for operating a pair of cameras 12 and 16 as a stereoscopic camera pair. The camera rig 10 comprises a rig frame 26 providing first and second camera mounts 14 and 18 for first and second cameras 12 and 16. The camera rig 10 further includes a mirror box 20 configured to operate as a beam splitter that reflects a portion of light incoming from a scene to be imaged, and transmits a portion of the incoming light.

According to this arrangement, the first camera mount 14 positions the first camera 12 below the mirror box 20, to receive the reflected light. The second camera mount 18 positions the second camera 16 behind the mirror box 20 to receive the transmitted light. The mirror box 20 includes a (tilted) mirror 36 operating as the beam splitter, and a mirror assembly 32 carrying the mirror 36 is configured to move linearly along a first axis that is nominally horizontal, so that the mirror 36 is movable closer to and further away from the second camera 16. The mirror assembly 32 is further configured to be movable linearly along a second axis that is orthogonal to the first axis and therefore nominally vertical, so that the mirror 36 is movable closer to and further away from the first camera 12. Here, the “nominal” axis orientation assumes that the camera rig 10 is in an upright position, where the first camera 12 mounts in a vertical orientation pointing upward toward the mirror box 20 and where the second camera 16 mounts in a horizontal orientation pointing through the mirror box 20.

As used herein, “orthogonal” means that the first axis is substantially perpendicular to the second axis within 0°, 1°, 2°, 3°, 4°, 5°, 6°, 7°, 8°, 9°, 10°, 11°, 12°, 13°, 14°, 15°, 16°, 17°, 18°, 19° or 20° of 90° (perpendicular). In some embodiments, the first axis is within 1° of perpendicular to the second axis. In some embodiments, the first axis is within 2° of perpendicular to the second axis. In some embodiments, the first axis is within 3° of perpendicular to the second axis. In some embodiments, the first axis is within 4° of perpendicular to the second axis. In some embodiments, the first axis is within 5° of perpendicular to the second axis. In some embodiments, the first axis is within 6° of perpendicular to the second axis. In some embodiments, the first axis is within 7° of perpendicular to the second axis. In some embodiments, the first axis is within 8° of perpendicular to the second axis. In some embodiments, the first axis is within 9° of perpendicular to the second axis. In some embodiments, the first axis is within 10° of perpendicular to the second axis. In some embodiments, the first axis is within 11° of perpendicular to the second axis. In some embodiments, the first axis is within 12° of perpendicular to the second axis. In some embodiments, the first axis is within 13° of perpendicular to the second axis. In some embodiments, the first axis is within 14° of perpendicular to the second axis. In some embodiments, the first axis is within 15° of perpendicular to the second axis. In some embodiments, the first axis is within 16° of perpendicular to the second axis. In some embodiments, the first axis is within 17° of perpendicular to the second axis. In some embodiments, the first axis is within18° of perpendicular to the second axis. In some embodiments, the first axis is within 19° of perpendicular to the second axis. In some embodiments, the first axis is within 20° of perpendicular to the second axis. Exactly orthogonal is perpendicular at 90°.

As used herein, “parallel” means that the first axis is substantially parallel to the second axis within 0°, 1°, 2°, 3°, 4°, 5°, 6°, 7°, 8°, 9°, 10°, 11°, 12°, 13°, 14°, 15°, 16°, 17°, 18°, 19° or 20°. In some embodiments, the first axis is within 1° parallel to the second axis. In some embodiments, the first axis is within 2° parallel to the second axis. In some embodiments, the first axis is within 3° parallel to the second axis. In some embodiments, the first axis is within 4° parallel to the second axis. In some embodiments, the first axis is within 5° parallel to the second axis. In some embodiments, the first axis is within 6° parallel to the second axis. In some embodiments, the first axis is within 7° parallel to the second axis. In some embodiments, the first axis is within 8° parallel to the second axis. In some embodiments, the first axis is within 9° parallel to the second axis. In some embodiments, the first axis is within 10° parallel to the second axis. In some embodiments, the first axis is within 11° parallel to the second axis. In some embodiments, the first axis is within 12° parallel to the second axis. In some embodiments, the first axis is within 13° parallel to the second axis. In some embodiments, the first axis is within 14° parallel to the second axis. In some embodiments, the first axis is within 15° parallel to the second axis. In some embodiments, the first axis is within 16° parallel to the second axis. In some embodiments, the first axis is within 17° parallel to the second axis. In some embodiments, the first axis is within18° parallel to the second axis. In some embodiments, the first axis is within 19° parallel to the second axis. In some embodiments, the first axis is within 20° parallel to the second axis. Exactly parallel is parallel within 0°.

As used herein, “vertical” means that an orientation is substantially vertical within 0°, 1°, 2°, 3°, 4°, 5°, 6°, 7°, 8°, 9°, 10°, 11°, 12°, 13°, 14°, 15°, 16°, 17°, 18°, 19° or 20°. In some embodiments, the orientation is vertical within 1°. In some embodiments, the orientation is vertical within 2°. In some embodiments, the orientation is vertical within 3°. In some embodiments, the orientation is vertical within 4°. In some embodiments, the orientation is vertical within 5°. In some embodiments, the orientation is vertical within 6°. In some embodiments, the orientation is vertical within 7°. In some embodiments, the orientation is vertical within 8°. In some embodiments, the orientation is vertical within 9°. In some embodiments, the orientation is vertical within 10°. In some embodiments, the orientation is vertical within 11°. In some embodiments, the orientation is vertical within 12°. In some embodiments, the orientation is vertical within 13°. In some embodiments, the orientation is vertical within 14°. In some embodiments, the orientation is vertical within 15°. In some embodiments, the orientation is vertical within 16°. In some embodiments, the orientation is vertical within 17°. In some embodiments, the orientation is vertical within 18°. In some embodiments, the orientation is vertical within 19°. In some embodiments, the orientation is vertical within 20°. Exactly vertical is vertical within 0°.

As used herein, “horizontal” means that an orientation is substantially horizontal within 0°, 1°, 2°, 3°, 4°, 5°, 6°, 7°, 8°, 9°, 10°, 11°, 12°, 13°, 14°, 15°, 16°, 17°, 18°, 19° or 20°. In some embodiments, the orientation is horizontal within 1°. In some embodiments, the orientation is horizontal within 2°. In some embodiments, the orientation is horizontal within 3°. In some embodiments, the orientation is horizontal within 4°. In some embodiments, the orientation is horizontal within 5°. In some embodiments, the orientation is horizontal within 6°. In some embodiments, the orientation is horizontal within 7°. In some embodiments, the orientation is horizontal within 8°. In some embodiments, the orientation is horizontal within 9°. In some embodiments, the orientation is horizontal within 10°. In some embodiments, the orientation is horizontal within 11°. In some embodiments, the orientation is horizontal within 12°. In some embodiments, the orientation is horizontal within 13°. In some embodiments, the orientation is horizontal within 14°. In some embodiments, the orientation is horizontal within 15°. In some embodiments, the orientation is horizontal within 16°. In some embodiments, the orientation is horizontal within 17°. In some embodiments, the orientation is horizontal within 18°. In some embodiments, the orientation is horizontal within 19°. In some embodiments, the orientation is horizontal within 20°. Exactly horizontal is horizontal within 0°.

The mirror box 20 is further configured to rotate the mirror 36 about a tilt axis 40 that runs horizontally within the above frame of reference, and to rotate the mirror 36 about an axis 42 that runs vertically within the same frame of reference. More particularly, the tilt axis 40 and the axis 42 intersect at a point on the mirror's reflective surface that is referred to as the mirror nodal point 44. Thus, tilting rotation of the mirror 36 is about the mirror nodal point 44 and other rotation is about the same point. This allows rotation adjustments to be independent of tilting adjustments, once the mirror nodal point 44 is aligned with the optical axes 60 and 54 of the first and second cameras 12 and 16, respectively. That alignment is achieved, as explained earlier, via the linear adjustment of the mirror 36, either closer to or further away from the first camera 12, and either closer to or further away from the second camera 16, all as needed to align the optical axes with the mirror nodal point 44.

In at least one embodiment, the camera rig 10 further includes an electronic adjustment system 120. In one such embodiment, the electronic adjustment system 120 is configured to make positional adjustments (linear and/or rotational) to the mirror 36 in response to user inputs. The user inputs may be provided through a hard-wired control interface, such as a hard-wired remote control, or may be provided through a wireless remote control. For example, the control system 120 may include an RF receiver (or transceiver for two-way signaling between the camera rig 10 and the remote control). The RF signaling may be based on a proprietary signaling protocol, or may be based on an industry-standard interface protocol, such as Bluetooth (or WiFi). Of course, the electronic adjustment system 120 may support more than one type of radio interface or protocol, and may support concurrent control inputs via the hardwired and wireless interfaces.

In one or more embodiments, each camera rig 10 includes a network or electronic ID or address, so that multiple camera rigs 10 are individually addressable and controllable. It will be understood that a command interface 128 of the control system may include an RF control interface 134, which includes radio frequency circuitry, such as received-signal filters, amplifiers, and down-converters, as needed. Such interface circuitry may further include digitizers and baseband processors, for producing digital values corresponding to the antenna-received RF signaling. These digital values may be provided as command signals to a control circuit 136, which interprets them as motor control commands and generates corresponding motor control signals.

However the control system 120 is implemented, the mirror articulation contemplated herein enables a rapid and accurate method of camera alignment. Assume that the first and second cameras 12 and 16 have been mounted in the camera rig 10 in the respective first and second camera mounts 14 and 18. Mounting the cameras 12 and 16 and making any default mounting positioning adjustments, such as setting the nominal horizontal displacement between the two cameras 12 and 16 via lateral adjustment available in one or both of the camera mounts 14 and 18, may be regarded as “gross” alignment.

With the cameras 12 and 16 fixed in their mounts 14 and 18, the mirror box 20 provides accurate, fine alignment of the key stereoscopic image adjustment parameters, including vertical displacement, and vertical angular displacement (tilt).

The adjustment method includes two steps. First, the camera rig 10 is pointed towards a distant object, toward infinity. With the two cameras 12 and 16 thus aimed at the distant object or infinity, the camera operator uses the control interface 128 of the control system 120 (and/or manual adjustment knobs 106 provided by the mirror box 20) to adjust the mirror tilt and camera pan angles, to bring the images of the two cameras into alignment with respect to their vertical and horizontal angular displacements.

Next, the camera rig 10 is pointed towards a nearby object. With the two cameras 12 and 16 thus aimed at the nearby object, the camera operator uses the control interface 128 and/or manual adjustment knobs 106 on the mirror box 20 to linearly move the mirror 36 up or down (along the y axis), and forward or backward (along the z axis), as needed to eliminate any vertical displacement between the first and second cameras 12 and 16. That is, the first step can be understood as making the transmitted optical axis 54′ of the second camera 16 vertical with the reflected optical axis 60′ of the first camera 12, while the second step can be understood as making them vertically even (coincident in the horizontal plane). Referring back to FIG. 12 for a moment, one sees that a video monitor or monitors may be provided, so that the operator can see the images from the two cameras and use that visual image as the basis for making alignment adjustments to the mirror box 20.

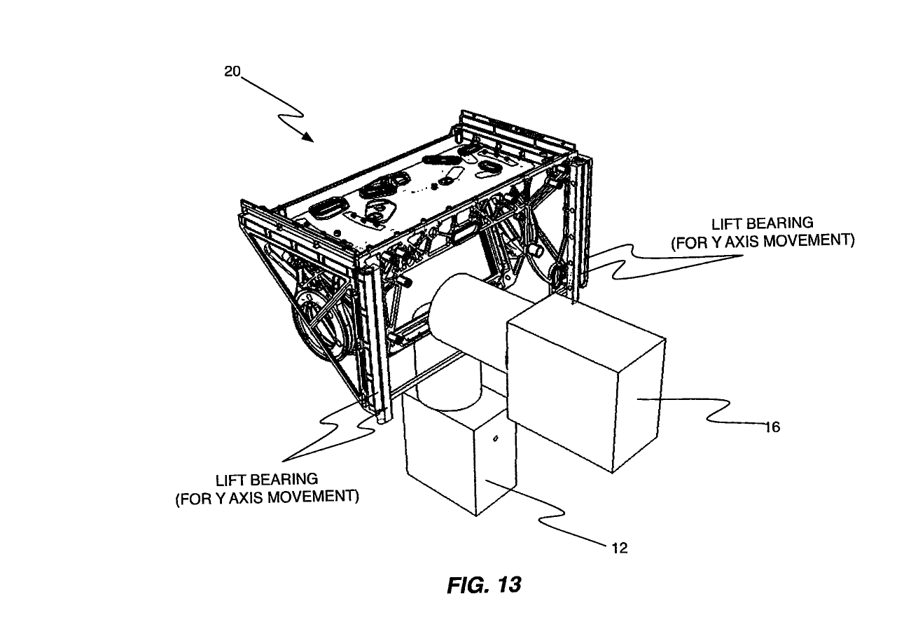

FIGS. 13-19 further illustrate various mechanical details, with a particular emphasis on illustrating example assemblies/sub-assemblies comprising the mirror box 20 in terms of mirror articulation, including linear translation along the y- and z-axes and rotation about the tilt axis 40.

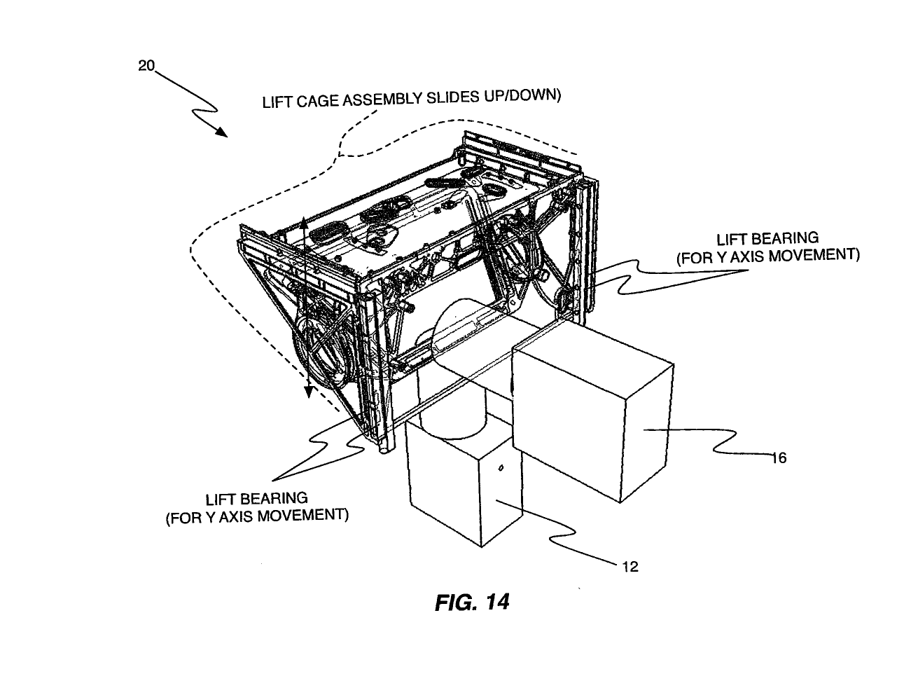

For example, FIG. 13 emphasizes the lift bearings that provide for up and down movement of the mirror 36 along the y axis. FIG. 14 provides a complementary illustration of those elements in the mirror box 20 that move up and down all of a piece to effect y axis translation of the mirror 36. The example illustration refers to this collection of mechanical elements as the “lift cage.” In one or more embodiments, the lift cage comprises the earlier carriage 30, which moves all of a piece along the y axis on the lift bearings.

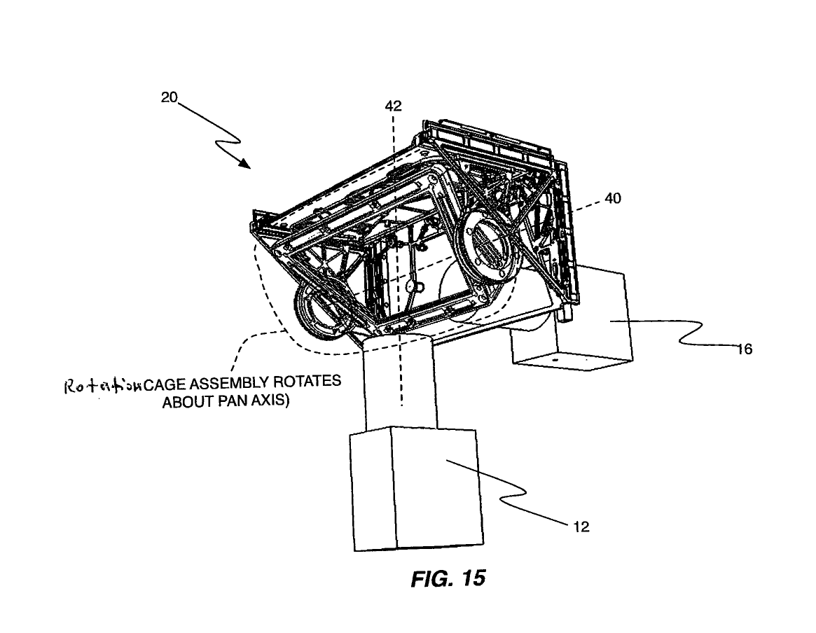

In turn, FIG. 15 illustrates an example embodiment where a “rotationcage” assembly is included within the lift cage assembly and is configured to rotate therein about the axis 42. The rotation cage assembly comprises, in one or more embodiments, the earlier described mirror assembly 32, which includes a mirror frame 34 carrying the mirror 36.

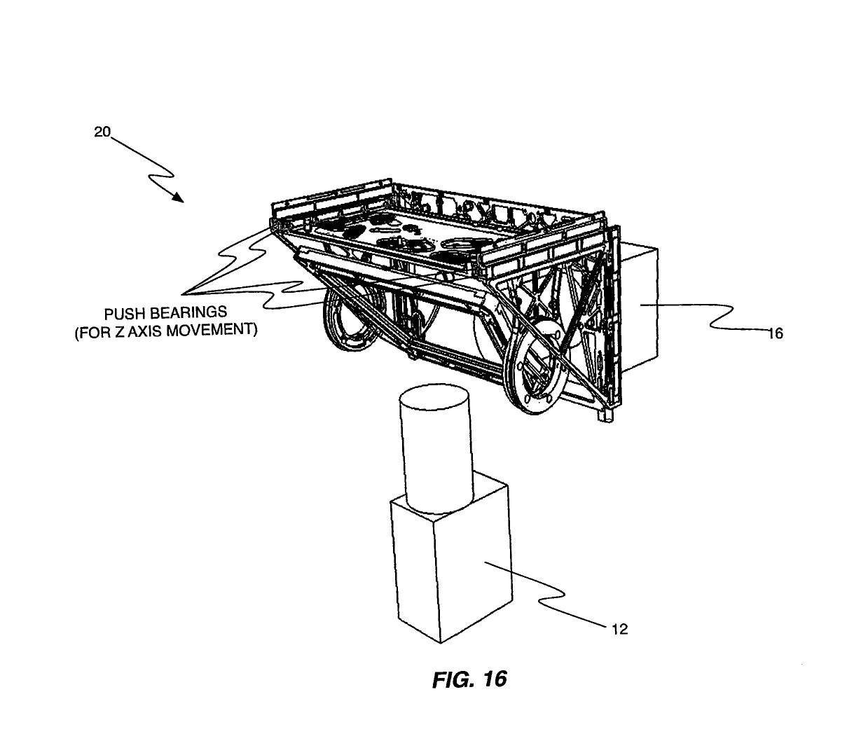

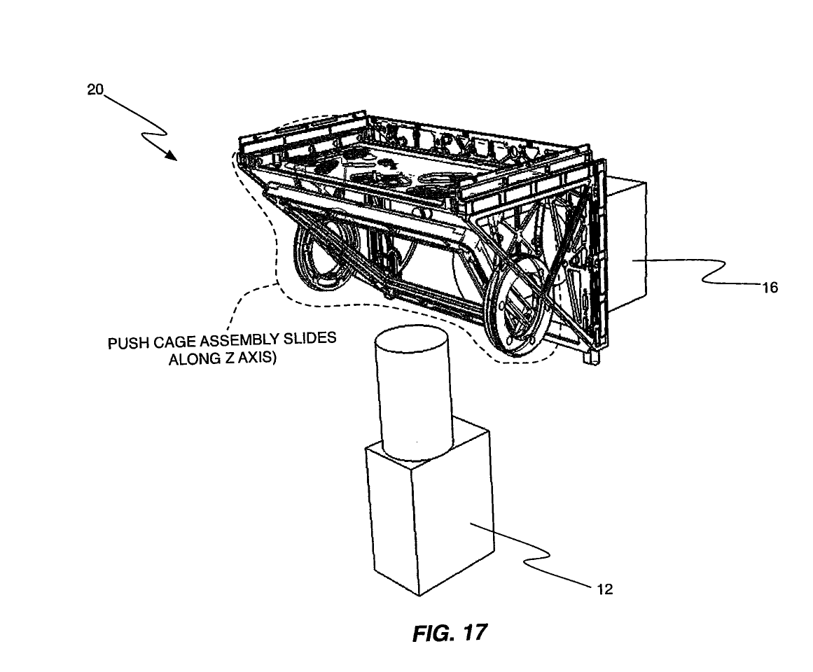

FIG. 16 illustrates push bearings that allow the lift cage assembly to slide forward and backward along the z axis. Thus, while the push bearings are carried within the lift cage assembly in terms of y axis translation of the overall lift cage assembly, all or part of lift cage assembly itself moves forward and backward along the z axis via sliding movement along the illustrated push bearings. FIG. 17 emphasizes an example of such an arrangement, wherein a “push cage” assembly is highlighted. Thus, in an example embodiment, the push cage assembly may comprise a subset of the lift cage assembly, and may itself be understood as including the rotation cage assembly.

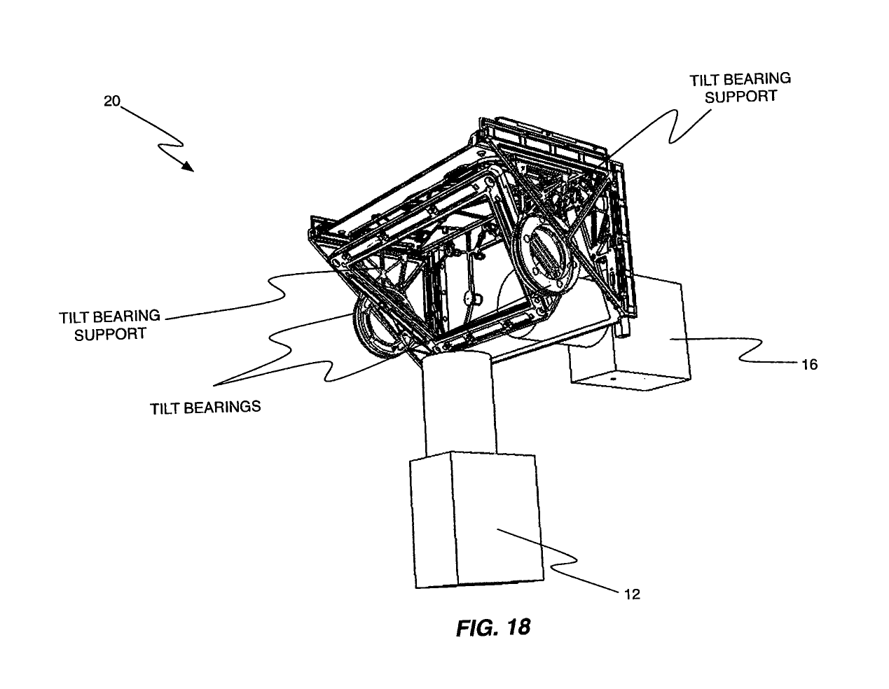

Still further, the rotation cage assembly itself may include tilt rotation mechanicals, which allow for the mirror 36 to be tilted and panned independently. In this example, then, the lift cage assembly carries the push cage assembly, which in turn carries the rotation cage assembly, which in turn includes a tilt mechanism for the mirror 36. FIG. 18 provides an example illustration of tilt bearings for tilt rotation of the mirror 36, along with respective tilt bearing supports that tie into or are otherwise integrated with the pang cage assembly.

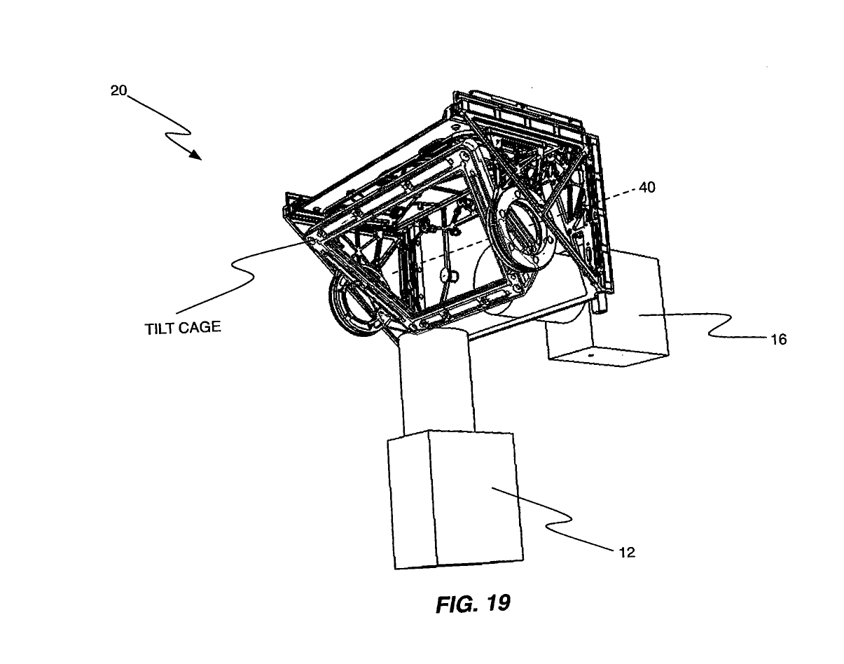

This example arrangement further includes a tilt cage assembly, which is shown in FIG. 19. The tilt cage assembly carries the mirror 36 and may be understood as comprising or including the earlier described frame 34. In any case, the tilt cage assembly “rides” on or is otherwise supported by the tilt bearings, which allows the tilt cage assembly to rotate, and thereby provides for rotation of the mirror 36 to be rotated about the tilt axis 40.

When operating on a standard movie set the per minute costs are very high due to high staffing levels, locations etc., therefore a 3D rig that allows rapid alignment can save a substantial amount of time and money for a production. Consequently, there are a number of known arrangements and methods for practical stereo image capture. As stated earlier, for stereo footage, the scene is photographed with two cameras, one for each of the viewer's eyes. (Note that “stereo footage” or “stereoscopic” footage is also referred to as “three-dimensional,” “3-D,” or, simply, “3D” filming.). Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A camera rig system for 3D stereo photography, the system comprising
a first camera mount configured to removably hold a first camera module having a first optical axis being oriented horizontally;
a second camera mount configured to removably hold a second camera module having a second optical axis being oriented vertically and orthogonal to the first optical axis;
a mirror assembly configured to receive an incoming light and transmit a first portion of the incoming light to the first camera module and reflect a second portion of the incoming light to the second camera module,
said mirror assembly has a first rotational axis, and the mirror assembly independently controls a rotational movement around the rotating axis and a linear movement along at least one of the first optical axis and the second optical axis, the first rotating axis being orthogonal to the first optical axis and the second optical axis.

2. The camera rig system of claim 1, further comprising a rig frame coupled to the first camera mount, the second camera mount, and a mirror box enclosing the mirror assembly.

3. The camera rig system of claim 2, wherein the mirror box comprises:
a rotational mount coupled to the mirror assembly and being configured for the rotational movement of the mirror assembly around the first rotational axis;
a carriage coupled to the mirror assembly and being configured for the linear movement of the mirror assembly along the first optical axis and the second optical axis such that a reflected optical axis of the second camera module and a transmitted optical axis of the first camera module are coincident at a reflective surface of the mirror assembly the transmitted optical axis being parallel to the first optical axis and the reflected optical axis being perpendicular to the second optical axis;
the carriage configured for the rotational movement of the mirror assembly around a second rotational axis and the rotational mount configured to carry the mirror assembly within the carriage, the second rotational axis orthogonal to the first rotational axis;
a first opening configured to allow the transmitted light to pass through toward the first camera module; and
a second opening configured to allow the reflected light to pass through toward the second camera module.

4. The camera rig system of claim 1, wherein the mirror assembly comprises:
a mirror; and
a mirror frame coupled to the mirror.

5. The camera rig system of claim 4, wherein the mirror comprises a beam splitter.

6. The camera rig system of claim 1, wherein the linear movement of the mirror assembly is along a horizontal axis within approximately 1.5 inches.

7. The camera rig system of claim 1, wherein the rotational movement of the mirror assembly is within approximately 2 degrees.

8. The camera rig system of claim 1, further comprising a motor configured to adjust the mirror assembly.

9. The camera rig system of claim 1, further comprising an electronic adjustment system configured to adjust the mirror assembly.

10. A method for aligning camera modules in a camera rig system for 3D stereo photography, the system comprising at least two fixed camera modules and a movable mirror assembly, the method comprising:
mounting a first camera module in a horizontal orientation and a second camera module in a vertical orientation onto respective camera mounts;
rotating the mirror assembly around a first rotational axis; and
moving the mirror assembly along at least one of a first optical axis of the first camera module and a second optical axis of the second camera module, such that the incoming light transmitting through the mirror assembly toward the first camera module and the incoming light reflecting from the mirror assembly toward the second camera module are coincident at a reflective surface of the mirror assembly,
wherein the first optical axis, the second optical axis, and the first rotational axis are perpendicular to each other, the mirror assembly is angled at roughly 45 degrees from the first optical axis or the second optical axis.

11. The method of claim 10 further comprising moving the mirror assembly along a horizontal axis.

12. The method of claim 10 further comprising moving the mirror assembly along a vertical axis.

13. The method of claim 10 further comprising moving the mirror assembly along both a horizontal axis and a vertical axis.

14. The method of claim 10, further comprising rotating the mirror assembly around the first rotational axis within approximately 2 degrees.

15. The method of claim 10, further comprising moving the mirror assembly within 1.5 inches.

16. A method for aligning camera modules in a camera rig system for 3D stereo photography, the system comprising at least two fixed camera modules and a movable mirror assembly, the method comprising:
mounting a first camera module in a horizontal orientation and a second camera module in a vertical orientation onto respective camera mounts;
moving the mirror assembly along a first optical axis of the first camera module and a second optical axis of the second camera module; and
rotating the mirror assembly around a first rotational axis such that the incoming light transmitting through the mirror assembly toward the first camera module and the incoming light reflecting from the mirror assembly toward the second camera module are coincident with an intersection point of the first rotational axis and a second rotational axis being perpendicular to the first rotational axis; and
wherein the first optical axis, the second optical axis, and the first rotational axis are perpendicular to each other, the mirror assembly is angled at roughly 45 degrees from the first optical axis or the second optical axis.

17. The method of claim 16 further comprising rotating the mirror assembly around the second rotational axis of the mirror assembly, the second rotational axis being parallel to the second optical axis of the second camera module.

18. The method of claim 16 further comprising moving the mirror assembly along a horizontal axis.

19. The method of claim 16 further comprising moving the mirror assembly along a vertical axis.

20. The method of claim 16 further comprising moving the mirror assembly along both a horizontal axis and a vertical axis.

21.-22. (canceled)
